(19) United States
(12) Patent Application Publication
(10) Pub. No.: US 2007/0054031 A1
(43) Pub. Date: Mar. 8, 2007

(54) Methods of extracting, concentrating and fractionating proteins and other chemical components

(76) Inventor: Keshun Liu, Pocatello, ID (US)

Correspondence Address: Keshun Liu, Ph.D., 1407 Shantel Pl., Pocatello, ID, 83201, US

(21) Appl. No.: 11/219,277

(22) Filed: Sep. 2, 2005

(51) Int. Cl. A23L 1/20

(52) U.S. Cl. 426/634

(57) ABSTRACT

Methods are disclosed herein to extract, concentrate and fractionate proteins and protein-associated complexes with other polymers from soybeans, peanuts, rape, canola, cottonseeds, peas, wheat and other plant materials, based on a principle of cryoprecipitation. The disclosed methods involve no or minimal uses of chemicals, and generate a minimal volume of waste streams. The resulting protein concentrates or isolates have excellent functionality, superior nutritional quality, attractive appearance and mild taste. Based on the sample principle of cryoprecipitation, methods also are also disclosed to extract and concentrate chemical components from living tissues, especially some nutraceutical or phytochemical components from plant materials.

### BACKGROUND OF THE INVENTION

1. Field of the Invention

The present invention relates to methods for extracting, concentrating and fractionating proteins, especially edible proteins from plant materials, such as oilseeds, legumes and cereals, and resulting protein concentrates and isolates that have excellent functionality, good nutritional values, mild flavor and taste, appealing color, and high levels of phytochemcials naturally presented in the original materials.

This invention also relates to methods of extracting and concentrating chemical components from living tissues, especially extracting and concentrating some nutraceutical and phytochemical components from plant materials.

2. Prior Art Description

Proteins of plant origin, particularly those from oilseeds, legumes, and cereals, are economical and renewable sources of dietary proteins. These proteins, also known as vegetable proteins, provide the most promising means of solving protein shortage that exists in the diets of over half the world's population. Furthermore, recent medical discovery about health-promoting effects of vegetable proteins as well as certain phytochemicals associated with them have made plant-based protein foods, such as soyfoods, especially popular in today's health conscious society.

Yet, most vegetable proteins, when present in their native state, are unpalatable due to undesirable flavor, color, texture, and have impaired nutritional quality due to the natural presence of certain antinutritional factors. There are extensive reports on methods for processing oilseeds, legumes and cereals directly into palatable foods. There are also extensive reports on methods for extracting and concentrating vegetable proteins, improving their nutritional, functional, and organolepic properties, and expanding their applications.

Soybeans are by far the world's leading oilseed crop. Traditionally, for thousands of years in China and other Far East countries, soybeans are processed directly into soymilk, tofu, soy sauce, tempeh, or other food products. However, at present, throughout the world, majority of annual soybean production is crushed and made into oil and defatted meal by modern processing. The oil fraction is refined and used mainly for human consumption. The defatted soy meal which contains about 50% protein, is used mainly as animal feed. Only a small portion of defatted meal is converted into soy protein concentrate and isolate for uses as food ingredients.

The term “concentrate” is generally considered in the art to include any product that contains higher concentrations of protein than the original source material. The actual percentages will vary, depending upon the source of the protein. For example, commercial soy protein concentrates typically have at least 70% protein (dry solids basis). The term “isolate” usually refers to a concentrate with at least about 90% protein by weight.

Efforts to concentrate proteins in oilseeds, such as soybeans, typically start with removing oil by solvent extraction (mostly hexane extraction), mechanical expression, or a combination. The next step is to remove insoluble carbohydrates (fiber) and/or soluble sugars, ash and some minor constituents from defatted oilseed materials, typically by means of alkaline extraction, acid precipitation, alcohol leaching, etc. Processes based on membrane filtration technology have been explored. Examples include U.S. Pat. No. 5,086,166 to Lawhon et al. (1992) and U.S. Pat. No. 6,630,195 to Muralidhara et al. (2003). Additional information on vegetable protein processing and utilization is available in numerous articles and books, including Liu, K. (the same Applicant herein), Soybeans as Functional Foods and Ingredients, AOCS Press, Champaign Ill., 2004.

However, current methods in concentrating plant proteins in general and soy proteins in particular have suffered from one or many of the following problems: (1) Most rely on use of alcohol, alkaline, acid, and other chemicals; (2) A considerable amount of waste stream is generated, causing environmental concern; (3) End products typically have poor color and salty or other undesirable taste and flavor; (4) End products lack of some key functional properties because proteins have undergone harsh chemical (such as acid, alcohol) and heat treatments; (5) There is considerable loss of beneficial phytochemicals naturally present in the original materials; and (6) Production yield is generally low.

In another aspect, plant seed proteins are classified based on a sedimentation coefficient upon ultracentrifugation into various globulins. For example, soybean proteins are classified into 2S, 7S, 11S and 15S globulins. Among them, 7S and 11S are major constituents of soybean seed proteins, corresponding substantially to beta-conglycinin and glycinin. Realizing the specific values for 7S and 11S proteins in soybeans, attempts have been made to fractionate each component to utilize its inherent functions. Most are based on a principle of fractional isoelectric precipitation, in which soybean protein components are fractionated using pH and temperature regulation in the presence or absence of certain salts. Examples include Rickert et al. (Improved fractionation of glycinin and beta-conglycinin and partitioning of phytochemicals, J. Agric. Food Chem. 52: 1726-1734, 2004), U.S. Pat. No. 6,566,134 to Bringe (2003), and U.S. Patent application 20040028799 by Ishikawa et al. (2004). However, almost all these methods have the following drawbacks: (1) The pH and temperature regulations are troublesome and cost-ineffective; (2) There is significant loss of phytochemcials; and (3) most of the methods are still limited to experimental stages.

Still, in another aspect, plant materials contain many minor components that are bioactive and have health-promoting effects. For example, besides oil and storage proteins, soybeans contain oligosaccharides, isoflavones, phytate, small molecular proteins such as Borman-Birk (BB) trypsin inhibitor, and peptides such as lunasin. Soy isoflavones belong to flavonoids, and have anti-cancer, cholesterol-reducing and other health benefits. Soy BB inhibitor has a MW of 8 KD and been shown to exhibit inhibitory activity against the malignant transformation of cells under certain conditions and its administration has been shown to affect various forms of cancer (St. Clair et al. 1990, Suppression of dimethylhydrazine-induced carcinogenesis in mice by dietary addition of the Bowman-Birk protease inhibitor, Cancer Res., 50:580-586.) Lunasin is a unique 43-amino acid peptide and has been shown to have a strong anti-cancer effect (Galvez A. F. et al. 2001, Chemopreventive property of a soybean peptide (lunasin) that binds to deacetylated histones and inhibits acetylation. Cancer Res. 61, 7473-7478).

Numerous items of prior art deal with extracting and separating biologically active components from plant materials. U.S. Pat. No. 4,428,876 to Iwamura (1984) and U.S. Pat. No. 6,703,051 to Bates and Bryan (2004) described methods for separating and revering both isoflavones and plant proteins. U.S. Pat. No. 5,217,717 to Kennedy et al. (1993) and U.S. Pat. No. 6,887,498 to Konwinski et al. (2005) disclosed methods for making concentrate soybean BB inhibitor products. U.S. Pat. No. 6,391,848 to de Lumen and Galvez (2002) describes compositions and methods for delivering effective amounts of lunasin as nutraceuticals. These methods suffer from (1) uses of vigorous treatments, such as heating, strong acid, strong alkaline, and/or various organic solvents; (2) multiple steps; and (3) difficulty to commercialize.

Considering all the aspects related to concentration, fractionation, and production of plant proteins in general and soy proteins in particular in the prior art, the overall object of this invention is to concentrate or fractionate proteins from plant-based materials by a novel method that can overcome some of the aforementioned concerns or drawbacks with the prior art.

Specifically, one object of this invention is to extract and concentrate protein from plant materials with no or minimal use of chemicals and without generation of large volume of waste stream.

Another object is to produce protein concentrates and isolates from plant-based materials with high recovery yield, and excellent nutritional, functional and organoleptic (bland taste, attractive color, high dispersibility, etc.) properties.

Another object is to produce full-fat protein concentrates from full-fat oilseed materials with high protein recovery yield, and excellent nutritional, functional and organoleptic properties.

Another object is to produce vegetable protein products that can be certified as organic product.

Another object is to fractionate plant-based proteins, such as those from oilseeds, legumes, and cereals, into different globulin-rich fractions for different end uses.

Still, considering some disadvantages of current art in extracting and concentrating bioactive components from plants, another object is to separate and concentrate some minor substances from proteins and protein-associated components in plant materials, and recover the minor substances.

Another object is to produce a protein product that is rich in soybean Borman-Birk trypsin inhibitor.

The new method is based on precipitation of proteins under low temperatures, known as cryoprecipitation. The basic principle of cryoprecipitation is that some proteins agglomerate when frozen, and then remain agglomerated when thawed if the temperature is kept sufficiently low. The technique based on cryoprecipitation has been used to separate certain proteins in medical fields, such as Factor VII, fibrinogen, and von Willebrands factor, from bulk plasma. One example is U.S. Pat. No. 3,631,018 to Shanbrom et al. (1971).

Prior art using the cryoprecipitation principle to separate and fractionate plant proteins includes: (1) separating the 11S protein from soybeans (Wolf and Sly, 1967 “Cryoprecipitation of Soybean 11S Protein,” Cereal Chemistry, 44:653-668); (2) fractionating soymilk by cryogenic precipitation (Johnson, 1978 “Processing Aqueous Extracts of Soybeans by Rapid-Hydration Hydrothermal Cooking”, Ph.D. Dissertation, Kansas State University, Manhattan, Kans.); (3) producing a novel protein curd from defatted soy material (U.S. Pat. No. 4,172,828 to Davidson et al. 1979); and producing a high-gelling protein fraction from defatted soybeans (U.S. Pat. No. 6,569,484 to Alli et al. 2003). Yet, all the reported methods except for Johnson's one used temperatures between 0-10 degrees C., had a very lower yield of protein recovery, and were targeted for producing a special fraction of proteins, mainly 11S proteins. Furthermore, some of the reports indicated that cryoprecipitated proteins or protein factions were polymerized through formation of intermolecular disulfide bonds (Wolf and Sly 1967) or even textured to form a non-homogeneous curd (Johnson 1978). Thus, the resulting protein products by cryoprecipitation were expected to have little functional uses.

### SUMMARY OF THE INVENTION

A novel method is disclosed herein to extract and concentrate protein and its association with other polymers such as lipids and carbohydrates, from soybeans, peanuts, cottonseed, peas, wheat, and other protein-rich materials. The method comprises: (1) preparing a plant material containing proteins; (2) mixing or blending the prepared plant material with an aqueous medium to extract or dissolve proteins and other components; (3) maintaining the mixture at a low temperature, with or without a prior step of removing the insoluble fraction; (4) thawing the mixture when necessary; (5) separating the precipitate fraction (cold insoluble fraction) from the supernatant (cold soluble fraction), and (6) restoring functional properties of the cold insoluble fraction by subjecting it to shear, heat or a combination. The method further comprises a step of treating the mixture before the low temperature treatment, a step of removing insoluble fiber before the low temperature treatment, a step of pasteurizing the final protein product, and/or a step of drying the final product.

Using the same principle, a novel method is also disclosed herein to separate and concentrate minor substances from a plant material by removing proteins and other components with larger molecular size. The method comprises: (1) preparing a plant material containing an bioactive ingredient by cleaning, size reduction, fermenting, drying, and/or other physical and biological treatments; (2) mixing or blending the prepared plant material with a solvent; (3) maintaining the liquid mixture containing said active ingredient at a cold temperature; (4) thawing the mixture when necessary; (5) separating the supernatant containing the bioactive ingredient from the precipitate; and (6) isolating and concentrating the bioactive ingredient from the supernatant.

It was found that subjecting an aqueous mixture (slurry or an extract) of a plant material to freezing and thawing treatments causes majority of protein as well as its associations with other polymers, such as protein-lipid complex when a full-fat oilseed material is used, to precipitate or aggregate. The recovery yield, which could be as high as 80%, is significantly higher than that of subjecting the same material to a temperature at zero or slightly above zero degree Centigrade. The lower the temperature and the longer the storage time, the more protein or its complex with other large size molecules precipitates. Based on this finding, a method of stepwise low temperature-time treatments, with each new treatment of the previous supernatant being lower in temperature and/or longer in duration, is also disclosed to fractionate proteins based on their molecular sizes. Proteins with larger molecular size precipitate first, while proteins with smaller molecular size precipitate in late treatments.

It was also found that functional properties of precipitated protein, such as solubility, emulsification, and gel formation properties, can totally be restored upon being subjected to shear, heat treatment, or a combination of the two.

The disclosed methods involve no or minimal chemical treatments, such as alkaline extraction, acid precipitation, alcohol leaching, and generate minimal volume of waste streams. Therefore they can be considered as a clean or green technology, particularly when natural temperature variations with seasons and geographic regions are utilized. The yield of recovery is comparable or even superior to technologies that are current being used. Furthermore, because of the cold temperature treatment and minimal chemical exposures, the isolated chemical component or a mixture of chemical components have superior nutritional, functional and/or organoleptic quality. The technology has broad-base applications, ranging from isolating and concentrating proteins to fractionating them from a plant material, from extracting and concentrating phytochemicals to isolating and concentrating certain whey proteins from plant tissues.

### BRIEF DESCRIPTION OF THE DRAWINGS

FIG. 1. Effects of water temperature on protein extraction and subsequent separation by cryoprecipitation from defatted soy meal (white flakes).

FIG. 2. Effect of freezing duration on protein precipitation from enzyme-active full-fat soy flour or defatted soy meal (white flakes).

FIG. 3. Effect of adding reagents to soybean water extracts on subsequent protein separation by cryoprecipitation.

### DETAILED DESCRIPTION OF THE INVENTION

As briefly summarized above, this invention discloses methods for extracting, concentrating and fractionating proteins and their associates with other polymers in various types of plant materials, particularly of seeds of oilseeds, legumes and cereals, including soybeans, peanuts, glandless cottonseed, sunflower kernels, peas, wheat, etc. For convenience, the discussion below describes how these steps can be performed on soybeans. Those skilled in the art will recognize how these particular steps, for soybeans and soybean proteins, can be adapted to work with other types of proteins and living tissues.

Starting Materials and Preparation

One major object of this invention is to extract and concentrate proteins from plant materials. Although based on the technique of this invention, any starting material from oilseed, legume, cereal, or other plant tissues containing proteins, can be used, a starting material that is in a dry particulate form and that its protein has not been severely denatured by heat or other means is preferred. The material is generally described as “enzyme-active”.

However, when a major object of this invention is to extract and concentrate minor components from major polymer components such as proteins, protein denaturation in a starting material is not a concern, and there is no preference for raw material selections on this regard as long as the raw material contains the component(s) of the interest.

Soybeans used in this invention can be any known varieties. Processes to prepare raw materials into dry particulate forms are commercially available. Briefly, raw beans are cleaned and dehulled to remove dust, hulls and other foreign materials. Cleaned and dehulled beans are then are subjected to one of the following three processing options: (1) flaking and full removal of the oil component to produce defatted soy material, (2) partial removal of the oil component and particle size reduction to produce low-fat soy material, and (3) reduction in particle size directly to produce full-fat soy material.

Full removal of oil component is typically carried out by solvent extraction. Common solvents include hexane or a supercritical fluid (such as supercritical CO₂), etc. The residual flakes are then desolventized. For most soy meals that are prepared for animal feed, solvent removal is commonly done in a desolventizer-toaster. During this operation, the flakes are superheated by steam, and enzymes as well as certain “anti-nutrients” (such as trypsin inhibitors) are inactivated. However, this desolventizing and toasting process denatures the protein and decreases its solubility. The resulting meal has a nitrogen solubility index in a range of 15 to 60. Here, the term “nitrogen solubility index”, abbreviated as NSL is defined as (1) the nitrogen content of a water-extractable portion of a food or feed sample that contains a protein, divided by (2) the total nitrogen content of the sample. The fraction that results is then multiplied by 100, being converted into a percentage value. To prevent proteins from denaturation, desolventizing under a mild heat condition can be carried out in a special device, such as a flashing desolventizing system. The resulting defatted flakes, commercially known as white flakes, generally have a NSI higher than 75. Almost all commercial protein concentrate or isolates are made from white flakes.

Partial removal of oil component is typically carried out by mechanical pressing or dry extrusion followed by expelling. Roughly half of the oil can be removed by conventional pressing operations. The resulting meal has oil content less than 10% of the dry weight of the beans.

Particle size reduction can be carried out in a mill, grinder, or other devices. The resulting material falls into one of three categories. The term “soy grits” includes coarse particulate materials that can pass through a standardized U.S. mesh ranging from 10, up to 100. The term “soy flour” includes finer particulates that can pass through U.S. mesh sizes of 100 or finer. The third category, “soy flakes”, includes flattened particulates. These are usually made through a rolling, flaking or hammering process.

Occasionally, soybeans may undergo some biological treatments, such as fermentation, before size reduction.

After preparation, defatted, low-fat, or full-fat soy particulate materials (grits, flour, or flakes), having either high NSI levels (such as white flakes, obtained by processes such as flash desolventizing) or low NSI levels (such as toasted meal, obtained by desolventizing-toasting) can be used for various different embodiments, and one type or the other is likely to be more suitable, depending on the needs and type (and on the desired quality, cost, and value levels) of a particular intended product, and depending on the different modes of processing disclosed in this invention.

It should be noted, however, that most particulate forms of soybeans, peanuts, and other crops can be obtained commercially in grits, flour, or flakes, with various fat contents (whole fat, low fat or defatted), allowing the purchaser to bypass any concerns over such preparative steps. In this case, the procedure can proceed to the next step directly.

Extracting Soluble Components

After completion of the preparative steps, the particulate soy material is ready for the next step of this invention, defined as the extraction step. It comprises mixing or blending soy material with water or other aqueous medium for sufficient time to dissolve water-soluble components including proteins, soluble carbohydrates (such as oligosaccharides), minerals, etc. This creates a slurry. As used herein, the term “slurry” refers to a mixture of a solvent and a plant material, where the fibrous fraction is not removed or reduced. When a lipid is present in the system, as in the case of full-fat or low-fat oilseed material, or as in the case of addition of a lipid preparation, the slurry is a protein-lipid emulsion or suspension.

During the extraction step, the extraction medium, the type of a raw material, the processing history of the raw material, the weight ratio of the solvent to solid material, the temperature and duration of extraction, and the mode of mixing and blending all have influence on (1) amount of soluble components to be extracted, (2) the amount of protein to be precipitated in the following steps, (3) the degree of ease in separating precipitates from supernatant, (4) the yield of the end product, and (5) the texture and functional properties of the final products. Some of these factors will be further discussed shortly under the subtitle of “Pre-Separation Treatments”.

Extracting solvents are generally polar solvents. An aqueous medium is generally preferred. An aqueous medium can be water, an alkaline solution, an aqueous alcohol solution, a salt solution, a buffer solution, and others. It should be noticed that solvents used for extraction influence not only the amount of protein to be extracted, but also the percentage of protein to be precipitated in the subsequent cold temperature treatment. In addition, if the object is to extract certain amount of chemical components rather than proteins, organic solvents, such as alcohol, acetone, etc., and various others or mixed types of solvents can be used. In any cases, it is appropriate to use a solvent that is usable for food. Examples include water, mild alkaline solution, and water-containing ethanol. In most cases, water is preferred.

The ratio of the aqueous medium to soy material also has an influence on separation efficiency of soluble materials from the hydrated slurry, amount of protein to be precipitated in the subsequent low temperature treatment, and the protein recovery yield of the resulting product. In general, the higher the ratio, the more protein can be extracted, the more protein is to be precipitated, and the higher the protein recovery yield. The ratio of the aqueous medium to soy material can be in the range of 3:1 to 50:1 by weight or by volume. The preferred ratios are between 6:1 and 25:1.

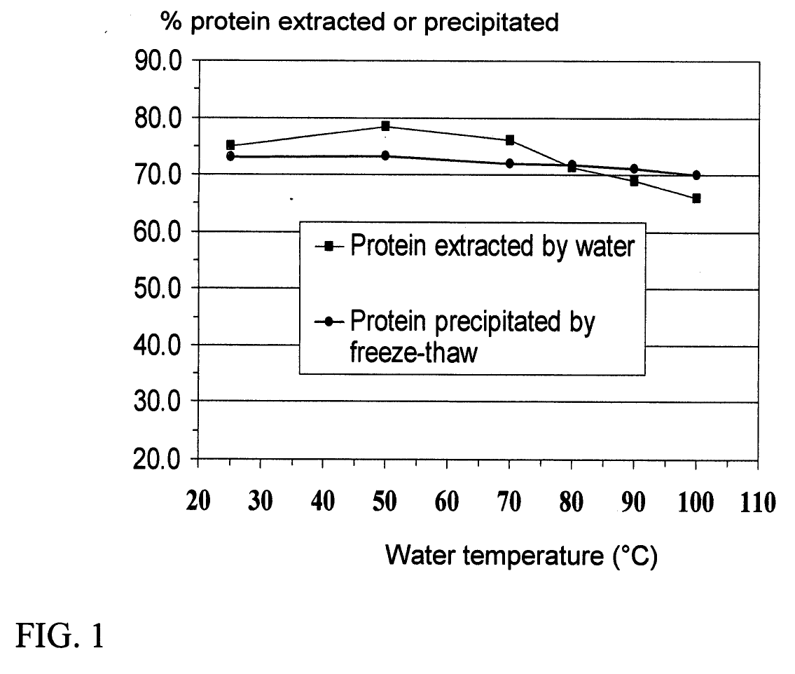

The extraction temperature can vary between a room temperature to as high as 100 degrees C. It has impact on protein extraction rate, taste and color of final protein products, and final protein recovery yield. For soy white flakes, the highest extraction rate is 50 degrees C. (FIG. 1).

There is no particular limitation as to the apparatus used for extraction, and a vessel designed for efficient extraction, a stirrer, a mixer, a blender, a homogenizer, a shaker, an extruder, a supersonic generator, etc., may be used.

As an option, some other ingredients, such as starch, lipid, additives, may be added before the extraction. These optional components can change composition, enhance protein recovery, and improve performance and properties of final products.

After extraction, the insoluble components (known also as soy fiber or okara) can be easily removed or reduced from the slurry. Any conventional solid-liquid separation procedures, such as sedimentation, cake filtration, clear filtration, centrifugal filtration, centrifugal sedimentation, compression separation or filter press, etc. can be used. The resulting supernatant is an extract. As used herein, the term “extract” refer to a mixture of a solvent and a plant material in which the fibrous fraction is removed or reduced.

However, the procedure of fiber removal is optional. It is performed when an object is to produce more refined protein products, such as soy isolate. When fiber is not removed but soluble fraction is removed following the cryoprecipitation step of this invention, the final product will be a protein concentrate. When an object is to extract and concentrate components with small molecular size, such as Borman-Birk trypsin inhibitor and oligosaccharides, fiber removal is also unnecessary.

Low Temperature Treatment

The aqueous mixture, with or without fiber removal, with or without some pretreatments (This aspect is to be discussed shortly), is now subjected to a cold temperature treatment. The temperature can be any temperature that is lower than 10 degrees C., although a freezing temperature is preferred. The low temperature treatment, particularly freezing, can induce several stresses that are capable of denaturing proteins, including ice formation, solute concentration, pH changes, etc. As a result, upon thawing, proteins precipitate, the phenomenon is known as cryoprecipitation.

It was found that fast freezing is preferred over slow freezing since fast freezing generally enhances cryoprecipitation. Before freezing, samples may be cooled at a refrigerator temperature.

It was also found that the lower the temperature, the more protein or its complex with other polymers such as lipids precipitates or aggregates, and the easier the precipitate or aggregate to be separated out upon thawing. On the other hand, the lower the temperature, the higher the cost it will be to generate and maintain the low temperature. Therefore, from a practical point of view, a preferred temperature range is a frozen temperature range that is somewhere between −2 to −80 degrees C. In the U.S., a typical freezer temperature is around −18 degrees C.

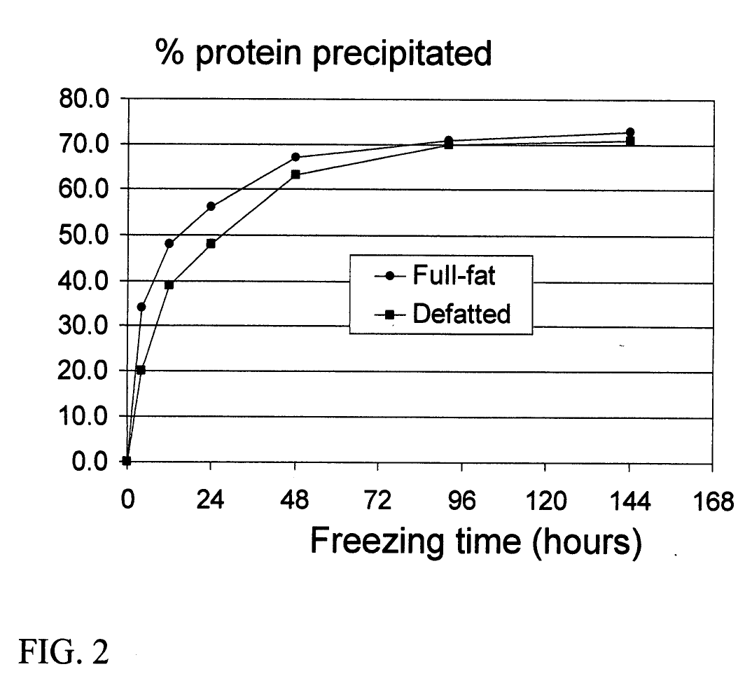

Furthermore, it was found that duration of the low temperature treatment also has profound effects on the amount of proteins to be precipitated and degree of ease for subsequent separation (FIG. 2). In general, the longer the storage, the more proteins precipitate and the easier the precipitates to be separated out late on. Noticeable cryoprecipitation of proteins typically requires duration of about 2 hours to about 10 days at a given frozen temperature. Although longer duration at a low temperature promotes more protein to be precipitated and thus increases protein recovery yield, it also increases the risk of irreversible denaturation of proteins so that functional properties of precipitated proteins become difficult or impossible to restore. In fact, prolonged freezing treatments, can lead to protein texturizaton due to extensive polymerization. The precipitate protein has oriented layers of structure, instead of a normal form of aggregates. Furthermore, prolonged freezing treatments increase energy cost also. Therefore, freezing for more than 30 days should be avoided.

Thawing

When a frozen temperature is used and if the mixture is frozen, the thawing step is necessary. It can be accomplished by putting the frozen samples at an atmosphere temperature higher than 0 degree C. and let them thaw gradually. During thawing, the atmosphere temperature can be varied. For example, putting frozen samples at a room temperature for first few hours and then move to a refrigerator temperature until all ice crystals melt. Yet, the temperature of the samples still has to be kept sufficient low, no more than 8 degrees C., in order to keep agglomerated proteins or other complexes from disperse, which can result in difficulty in separation and reduced protein recovery yield. Furthermore, to let the samples thaw at a temperature too high, or for a period of time too long, microorganisms would act and cause quality deterioration of final products.

It was found that, unlike freezing (for which fast freezing enhances cryoprecipitation), slow thawing causes more protein to precipitate than fast thawing. Therefore, it is preferred that frozen samples be thawed slowly at a refrigerator temperature until all ices meld. In this case, depending on the sample size, thawing may take several days. Also, during thawing, one needs to make sure that the mixture is kept still. Shaking and any abrupt movements can cause aggregates to disperse and difficulty in separate the precipitate from supernatant.

Separating Aggregates from Supernatants

Once the low temperature treatment is complete, or once the thawing step is complete as evidenced by complete melting of ice crystals, separation of precipitates need to be carried out within the short possible time, preferably within a few hours, while keeping the samples at a refrigeration temperature. Any conventional separation procedure, such as centrifuging, filtering, etc. can be used. Decanting or siphoning the top clear supernatant can also be used. Furthermore, to avoid dispersing the cryoprecipitate during separation, a low temperature environment is preferred.

As used herein, the term “cryoprecipitate” refers to the precipitate obtained from a cold temperature treatment of extracts (when fiber is removed or reduced before the cold treatment) or slurry (when fiber is not removed or reduced) made from oilseeds, legumes, cereals or other materials and separated from the supernatant fraction of the extract or slurry. The cryoprecipitate is also referred to as “cold precipitate” or “cold precipitate fraction” in this application. In contrast, the supernatant fraction is referred to as “cold soluble” or “cold soluble fraction”.

During concentration and purification of vegetable proteins by cryoprecipitation technique, there is an inevitable loss of proteins in the supernatants, just as methods of other protein concentration. Although the procedures described in this invention may appear to be simple, they require great care to harvest an optimal amount of proteins.

The supernatant or cold soluble fraction can be considered as a byproduct of the protein separation and purification process disclosed in this invention. Yet it contains many valuable components. These components can be further recovered by methods known in the prior art, such as extraction with a selected solvent, membrane filtration, partition, evaporation, etc.

In fact, if isolation and separation of chemical components in the liquid portion after cryoprecipitation is the main object, this liquid fraction deserves further attention. Further discussion under a separate subheading is followed shortly.

Restoring Functionality of Cryoprecipitated Proteins

Early researchers who worked on food protein separation and fractionation by cryoprecipitation found that the precipitated proteins or protein factions were polymerized through formation of intermolecular disulfide bonds (Wolf and Sly, 1967, Cryoprecipitation of Soybean 11S Protein, Cereal Chemistry, Volume 44, pages 653-668) or even textured to form a non-homogeneous curd (Johnson, L. A. 1978, Processing Aqueous Extracts of Soybeans by Rapid-Hydration Hydrothermal cooking, Ph.D. Dissertation, Kansas State University, Manhattan, Kans.). Thus, the resulting protein products by cold precipitation were expected to have little functional uses. This early finding or assertion has been a major obstacle for using the cryoprocipitation technique for food protein precipitation so far.

When the conditions are properly controlled, the cold precipitated protein or protein-lipid complex made according to the method of this invention is in an aggregate or particulate form. It is indeed appears to be poorly soluble in water and have poor functionality by first impression. Yet, one of significant findings in this invention is that cryoprecipitated protein can restore its solubility and other functional properties almost completely if the following treatment is made. The treatment comprises of (1) dispersing the aggregate protein into water to make a slurry, and (2) subjecting the slurry to one of the following: (a) a high shear environment, such as high shear mixing, blending or homogenization, (b) a high temperature short time treatment, or (c) a combination of (a) and (b), such as a direct steam injection system, commonly known as jet cooking. This important finding removes the obstacle and paves a new way for using cryoprecipitation to separate, concentrate and fractionate proteins from edible sources.

In general, when conditions are properly controlled, loss of functional properties of a protein as a result of cold temperature treatment is less severe and easier to be restored than loss of functional properties of a protein as a result of high temperature or chemical treatment. Therefore, a low temperature and high shear treatment is effective and is considered as a preferred mode of restoration of cryoprecipitated proteins for functionality.

In a preferred mode for restoring functional properties for cryoprecipitated proteins, wet protein aggregates, residues after separating of supernatants of frozen-thawed protein mixture, are suspended with 0-4 portions of water. The mixture is subjected to a shear-generating device, such as a homogenizer, a blender, high shear mixer, or a like. The mechanical shear is performed for at least 1 min. The temperature is maintained in the range of 25 to 100 degrees C. After the treatment, the protein suspension turns into a protein solution.

In another embodiment, restoring protein functionality can be done through combining heating and high shear, such as jet cooking commonly known as direct steam injection. This special treatment is particularly important when the starting material has low NSI and a final product is a protein concentrate (there is no fiber removal step). The jet cooking treatment is also useful when a heat treatment for final protein products is necessary to eliminate some trypsin inhibitory activities and/or reduce load of microorganisms (pasteurization).

Restoring functionality of cryoprecipitated protein can also be done after the protein is dried, and before or during its final application in a food system. In this case, since water is not added to the aggregates, it is more cost efficient to dry the precipitate protein directly into a final powder product.

Pre-Separation Treatments

Before the step of the low temperature treatment, there are a few optional treatments available. Some of these treatments can be carried out only before or during the step of extracting soluble components. Others can be performed only after the extracting step. Still others can be carried out in either step. All these treatments are defined as pre-separation treatments. The objectives of conducting these treatments are multiples: (1) to increase the amount of soluble components (including proteins) to be extracted, (2) to reduce microbial load and prevent spoilage during subsequent process, (3) to restore protein solubility and other functionality, (4) to increase the amount of protein to be precipitated in the subsequent steps, (5) to facilitate subsequent separation of precipitates from supernatant, (6) to improve taste and visual appearance such as color of the final product, and (7) to improve texture and functional properties of the final products.

One type of pre-separation treatments is application of a heat treatment. It can be applied during or after the protein extraction step but before the low temperature treatment step (FIG. 1). The purpose is multiple. It can improve protein extraction, reduce microbial loads and prevent spoilage during subsequent process. The heat treatment can also kill some enzymes and prevent off-flavor formation. However, the heat treatment before protein separation, if not controlled properly, can cause protein denaturation, low protein recovery yield, discoloration and other problems. It will affect cryoprecipitation of proteins to be separated and concentrated.

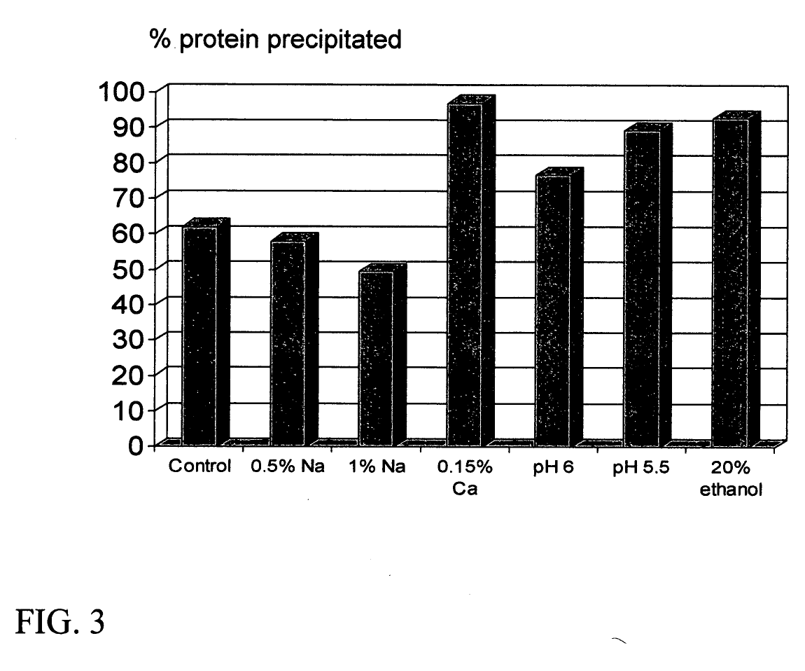

Another type of pre-separation treatments is addition of certain additives. This is to improve cryoprecipitation, increase protein recovery yield or improve separation of soluble components in the supernatant (FIG. 3). Examples include (1) using an aqueous medium instead of pure water for extraction, (2) adjusting pH to an acidic range for the slurry or extract after the extraction step, and (3) adding certain additives before or after extraction, which are known to enhance cryoprecipitation or have other functions.

Extraction with an aqueous medium is briefly covered in the previous subsection of “Extracting Soluble Components”. The aqueous medium can contain a base, a salt, an alcohol, etc. The purpose is multiple: (1) increase protein extraction, as example of extraction with a mild alkaline solution; (2) increase extraction yield of other components, (3) enhance cryoprecipitation during low temperature treatments, and/or (4) facilitate separation of cryoprecipitate.

Treatments after the extraction and before the cold temperature treatment include pH adjustment and uses of additives. At this stage, the purpose is to enhance cryoprecipitation and facilitate protein separation. Try to avoid any reagents that protect proteins from denaturation and precipitation during the cold storage.

When a base is added to the extraction medium, neutralization with an acid, such as HCl solution, is necessary after the extraction. Even when a base is not added to the extraction medium, such as using pure water, pH adjustment of resulting extracting mixture (slurry or extract) to an acidic range, preferably 5.0-6.5, will significantly improve cryoprecipitation and enhance separation (FIG. 3).

Cryoprecipitation is generally believed to result when the removal of water from the immediate vicinity of the protein molecules causes the protein molecules to preferentially associate with each other rather than with water. Certain additives that can “tie up” with water, such as alcohol, ammonium sulfate, and calcium salt, etc. can be added directly to the extracting mixture (slurry or extract) before the low temperature treatment to improve precipitation.

Pretreatments with additives as well as acidification, not only increase yield protein precipitation at frozen temperature, but also simplify the process by decreasing the requirement for deep freezing. In other words, deep freeze becomes less important if the extracting mixture is treated with an additive and/or acidified.

However, some additives, such as alcohols, although effective in increasing the yield of cryoprecipitate, their use usually necessitates additional washing or removal steps to ensure that the additives are not carried over into the final product. Some additives, such as calcium salts, may also damage or denature the labile proteins one is seeking to purify. So, it is to be cautious in selecting and using an additive. In most cases, pretreatment is not needed.

Still, other pre-separation treatments include concentration, dilution, clarification, fermentation, etc., depending on what a raw material, solvent, and solid/water ratio are used and what a final product is to be made.

Additional Post-Separation Treatments

In the post-separation stage (after freezing and thawing), beside the step of restoring protein functionality, several additional treatments may be used, including heating, pasteurizing, neutralization, solvent removal, further separating, concentrating, drying, etc. Most of the treatments are optional, depending on what a particular starting material is used, whether a particular pre-separation has been made or what final product is desired.

For certain end products, heating is needed to destroy trypsin inhibitor activities, improve nutritional and functional properties, and reduce microbial loads (pasteurize the products). Any heating methods can be used, including direct steam injection (jet cooking), indirect steam heating, etc.

Before the low temperature treatment, if a base or an acid is added to the extraction medium or the extract, neutralization with an acid or a base may be necessary. Also if an alcohol is used, desolventizing is needed. If a salt solution of relatively high concentration is used, washing may be necessary to remove some salt.

After all the necessary post-separation treatments, a final step is drying. Various drying methods, such as spray drying, drum drying, freeze drying, and the like can be used as long as the procedure does not significantly denature the soy protein and damage its functional properties.

If the interest lies with some components in supernatants, concentration and further separation of the components are necessary, using additional methods known in the prior art, such as evaporation, membrane filtration, acidification, precipitation, solvent partition, chromatography, etc. This subject is to be further discussed shortly.

Also, during the freeze-thaw treatment, ice crystal removal can serve as a purpose to concentrate solutes of interest in the mixture, as well. In this case, separation and isolation of a particular soluble component can be carried out by cryoprecipitation of components with large molecules and concentration of supernatants at the same process.

Fractionating into Different Protein Components

Proteins from an oilseed, legume or cereal, are mainly storage proteins of different types, which differ in structure, molecular size, and physical chemical properties. For examples, soybeans contain two major storage proteins: 7S and 11S globulins. Since these globulins have different structure and molecular size, the rate of cryoprecipitation and sensitivity to time-temperature treatment would expect to be different.

Accordingly, by manipulating the temperature and time combination of a low temperature treatment, plus selection of a pre-separation treatment, fractionation of these globulins becomes possible. Because each globulin has different physiochemical properties and nutritional quality, fractionation of vegetable proteins would expand protein utilization and increase end use values.

In one embodiment, a soy protein extract is stored at −10 degrees C. for 5 hours, and then thawed at a refrigerator temperature for 16 hours. At this short time and relatively less deep frozen temperature, proteins with large molecular size, such as 11S globulin, would precipitate while proteins with low molecular size remain in the solution. The precipitate is separated from supernatant to become an 11S-rich fraction. The supernatant is further treated at a lower temperature for longer time, such as −18 degrees C. for 3 days. Such prolonged storage at deeper freezing temperature causes most 7S globulin to precipitate. It is then separated by decantation to become a 7S-rich fraction. The components remain in the supernatant are sugars, minerals and some other proteins with smaller molecular size. The two fractions are treated with a procedure to restore functionality as just described and then dried.

In another embodiment, a soy protein extract is adjusted to a pH of 5.5 with a 2N HCl solution. The extract is treated at 4 degrees C. for 24 hours. At this acidic medium, 11S proteins start to precipitate even at 4 degrees C. The precipitate is separated by centrifuge to become an 11S-rich fraction. The supernatant is further treated at a lower temperature for longer time, such as −18 degrees C. for 2 day. Such prolonged storage at deeper freezing temperature causes 7S globulin to precipitate. It is then separated by centrifugation to become a 7S-rich fraction. The components remain in the supernatant are sugars, minerals and other components with smaller molecular size. The two fractions are then neutralized a 1N NaOH solution, and then treated with a procedure to restore functionality as described early, and finally dried.

In this invention, the disclosed method of stepwise low temperature-time treatments, with each new treatment of the previous supernatant being lower in temperature and longer in time, fractionates proteins based on their molecular size and sensitivity to cryoprecipitation. Proteins with larger molecular size and higher sensitivity to cryoprecipitation precipitate first, while proteins with smaller molecular size and lower sensitivity to cryoprecipitation precipitate in a late treatment. This stepwise method is fundamentally different from the method of Wolf & Sly (1968, Cryoprecipitation of soybean 11S protein, Cereal Chem. 44: 653-668), although both are based on the principle of protein cryoprecipitation. In the Wolf & Sly's method, cryopprecipitation was carried out at 0-2 degrees C. for 16-18 hours. After the 11S rich fraction was separated, the proteins in the supernatant, presumably include 7S protein, was discarded. Therefore, the yield of total protein recovery was rather low, only about 16-20%. In this newly developed method, both 11S and 7S fractions can be recovered from soybean protein extracts. When the two fractions are combined, the yield of total protein recovery can reach as high as 70%. Lower temperature and longer duration treatment, plus additional deeper freezing temperature treatments and pH adjustment, all help improve protein separation and precipitation, and drive the recovery yield high in this invention.

Properties of Concentrated Protein Products

When an enzyme-active soybean particulate material (either full-fat or defatted) is used as a starting material, the final protein concentrate or isolate, when made according to the preferred mode of this invention, has excellent functionality and visual appearance. When dissolved or dispersed in water, the product has excellent solubility or dispersibility. The solution or emulsion is very stable. There is little settlement even after several days of storage at a refrigerate temperature. When heating the solution, there is also no settlement. At a relative higher concentration, about 15% or higher, after heating of the solution, the protein forms a strong gel upon cooling. Some even forms gels during the heating stage.

The color is also appealing. It is creamy white to white, and is closed to dairy milk appearance. The embodiment that uses little heat treatment before or after the low temperature treatment typically produces a product with whitest color.

The product has very low levels of oligosaccharides, similar to commercial soy protein products. Furthermore, it is also low in phyate.

When no additives are used, and when full-fat or low fat soy material is used, the final product can be certified as organic food product. The same is true when a defatted soy meal is used, for which oil is removed by a supercritical carbon dioxide extraction or mechanical means.

Because of superior functional properties and other features, the concentrated protein products (soy concentrates or isolates) obtained by the disclosed method have a broad application in various food systems. Methods of using these products as food ingredients are known in prior art.

Using Natural Temperature Variations

Although the process disclosed herein has many advantageous features over the current art, including using no or minimal chemicals, generating less waste stream, making protein concentrates and isolates by similar procedures and equipment, and producing final products that have excellent functional properties, attractive visual appearance, and good retention of beneficial phytochemicals, it is not without some drawbacks. One major drawback for the new method is its high-energy input for freezing and thawing operations.

In order to overcome the drawback, it is desirable to use natural freeze and thaw processes by taking advantages of natural low temperatures in winter seasons and/or northern regions, or of natural temperature variations among geographic regions.

For example, freezing can be carried out outdoor in regions that reach sub-freezing temperatures (e.g. large areas of the U.S. and Canada) during winter and spring seasons. To save energy further, freezing and thawing can be operated in two separate regions: freezing in cold region and then transported to nearby warm region for thawing, or in a high mountain where the summit reaches sub-freezing temperatures while the valley can be above freezing temperatures. Using any of these natural approaches, the process disclosed in this invention can potentially become a green and cost efficient process for concentrating and fractionating vegetable proteins.

Recovering Valuable Components from Supernatants

After separation of cryoprecipitated protein fraction, the supernatant or cold soluble fraction is generally considered as a byproduct of the protein separation process. Yet, because the current invention uses no or little chemicals to separate proteins, the supernatant is relatively clean as a starting material for recovering many valuable components it contains.

The components naturally present in the original soy material are mostly water-soluble types. They include soluble carbohydrates (mostly oligosaccharides), small molecular proteins and peptides, phytate, lecithin, minerals, water-soluble vitamins (such as thiamin, riboflavin, niacin, pantothenic acid and folic acid), etc. Many of these components are biologically active and have values as phytochemcials for health promotion. Therefore, recovery for some of these components is desirable.

Furthermore, when extracting and separation of chemical components in the liquid portion after cryoprecipitation is the main object, this liquid fraction becomes a focus of attention.

Recovery of soluble carbohydrates, bioactive proteins and peptides, such as trypsin inhibitors and lunasin, and other components in the supernatant after the freeze-thaw treatment requires additional steps, including but not limiting to ultrafiltration, acid precipitation, alcohol extraction, acetone extraction, calcium precipitation, another cycle of cold temperature treatment, centrifugation, washing, drying, and a combination thereof.

Methods of concentrating the liquid fraction containing an active ingredient include concentration under heating and reduced pressure, concentration under heating and atmospheric pressure, concentration with a spray drier or with drum drier and concentration by freeze-drying, among which concentration under heating and reduced pressure is preferred.

Drying methods include drying under heating and reduced pressure, drying under heating and atmospheric pressure, or drying with a spray drier or with drum drier, or freeze-drying.

In one embodiment, the supernatant (cold soluble fraction) is passed through an ultrafiltration membrane system to yield a retentate having proteins and peptides that are rich in typsin inhibitors and lunasin. A spiral wound membrane with a molecular weight cutoff (MWCO) from about 1,000 to about 20,000 is suitable for use in this ultrafiltration step. A membrane having a MWCO of about 1,000 to about 5,000 is particularly useful in this ultrafiltration step. The resulting retentate may then be spray dried. The remaining liquid is concentrated and dried to recover soluble carbohydrates.

In another embodiment, the cold soluble fraction is treated with 1-4 volumes of acetone. After mixing for 5-10 min and settling for 1-2 hours, the mixture is centrifuged. The precipitate is rich in BB inhibitor. The acetone in supernatant is evaporated off and the remaining liquor is treated with 1-3 volumes of alcohol. The mixture is centrifuged again. The new precipitate is rich in Kunitz trypsin inhibitor and lunasin. The new supernatant is evaporated to drive off alcohol and then concentrated and dried to recover soluble carbohydrates. Alternatively, instead of treating with alcohol, the remaining liquor is diluted with 1-3 volumes of water. The mixture is subjected to an ultrafiltration treatment to obtain a retentate that is rich in Kunitz inhibitor and other small molecule proteins and peptides. The soluble carbohydrates are then recovered from the passing liquor.

To illustrate the invention and the manner of practicing the same more fully, the following examples are presented. Without being limited thereto, modifications will be obvious to those skilled in the art.

### EXAMPLES

### Example 1

### Effects of Extracting Temperatures

To demonstrate the effect of extracting temperature on protein extracted and then precipitated in the subsequent freezing-thaw treatment, the following experiment was conducted, using defatted soy meal having a NSI of 84% (white flakes). To a 1.5 liter cup fitted to a home blender, 1000 ml of water was added. The water temperature varied at 25, 50, 70, 80, 90, and 100° C. for each trial. After adding 70 g of white flakes, the mixture was blended for 2 min at a higher speed. The slurry samples were filtered through cloth immediately. The filtrates were measured for protein content. The filtrates were frozen at a home refrigerator's freezing chamber for 5 days, and thawed at a refrigerator temperature for 48 hrs.

The protein in the filtrate extracted from defatted soy flakes precipitated as a result of the freeze-thaw treatment. The supernatant was carefully decanted and tested for protein content. The residue was precipitated protein. The amount of protein precipitated was calculated by the difference between the protein content in the original extract and the protein content in the supernatant after the freeze-thaw treatment.

FIG. 1 shows the effect of water temperature on protein extraction and subsequent separation by lower temperature treatment from soy white flakes. With increasing temperature, protein extraction rate first increased and then decreased, with 50 degrees C. temperature having highest extraction rate. On the other hand, extraction temperature had little influence on protein precipitation in the subsequent freeze and thaw treatment. Overall, about 65-78% protein could be extracted. About 73% of the extracted protein could be precipitated upon the freeze-thaw treatment. Therefore, in this experiment, the protein recovery rate was about 47-57%.

### Example 2

### Effect of Duration of Cold Temperature Treatment on Cryoprecipitation

To a 1.5 liters cup fitted to a home blender, 1000 ml of tap water and 75 g of defatted soy white flakes (with a NSI of 84) were added, and blended immediately for 1.5 min at a higher speed. The slurry was filtered through cloth. The filtrate was poured into 6 bottles, each containing 100 ml. The remaining filtrate served as a sample for zero time of freezing. Its protein concentration was tested. The other six samples were frozen at a home refrigerator's freezing chamber for various durations: 4 hours, 12 hours, 1 day, 2 days, 4 days and 6 days, respectively. At each of 6 durations of freezing the sample was taken out and thawed at a room temperature for 3 hr and then at a refrigerator for additional 20 hrs. The protein in the extract precipitated as a result of the freeze-thaw treatment. The supernatant was decanted carefully and saved. It was mixed well and tested for protein concentration. The amount of protein precipitated was calculated by the difference between the protein content in the original extract and the protein content in the clear supernatant after the freeze-thaw treatment.

Another set of samples was prepared in a similar procedure except that 84 g of full-fat soy flour (100 mesh size, enzyme-active) was used.

Results are shown in FIG. 2. As the freezing time increased, the amount of protein precipitated, expressed as % of total protein in the original filtrate before freezing, increased. In the initial 3 days of freezing, the increase was dramatic. After the 3 days, further freezing caused only a slight increase in the amount of cryoprecipitated protein. This change pattern in % of protein precipitated with increasing duration of the low temperature treatment was similar for both defatted and full-fat soy samples, but the full-fat soy material required less amount of freezing time to reach a similar level of cryoprecipitation.

### Example 3

### Effects of Additives or Acidification on Cryoprecipitation

To investigate the effect of certain additives or pH adjustments, the following experiment was conducted using full-fat soy flour. To 1.5 liters cup fitted to a home blender (Oster), 75 g of full-fat soy flour and 1000 ml of tap water were added and then blended for 2 minutes. The slurry was filtered through cloth immediately. The filtrate was measured for protein content. The filtrate (extract) was divided into 7 portions, each equaling to 100 ml. To series portions of the extract, the following chemicals were added in order, at the concentrations specified as NaCl, 0.5%, NaCl, 1.0%; CaCl₂, 0.15%; and ethanol, 20%. Two portions of the extract were adjusted with HCl to a pH of 6 and 5.5, respectively. The water extract with no additive served as a control. After thorough mixing, the samples were frozen at a home refrigerator's freezing chamber (temperature was about −18° C.) for 5 days and thawed completely at a refrigerator temperature. The protein-lipid complex in the filtrate (extract) precipitated as a result of the freeze-thaw treatment. The top supernatant was carefully decanted and tested for protein content.

The percentage of protein precipitated for each treatment and the control is presented in FIG. 3. The results show that ethanol, acidification, and CaCl₂ addition increased cryoprecipitate production significantly as compared with control. In contrast, addition of NaCl at a concentration of 0.5% or 1% actually decreased the amount of protein to be precipitated. The results also show that under the freeze-thawing treatment, slightly acidification, such as adjusting pH to 5.5, can dramatically cause protein to precipitate. In contrast, in the normal isolate protein production, pH has to be adjusted to a very acidic range, such as around 4.5, in order to cause majority of protein to precipitate. Pretreatment with certain additives as well as acidification, not only increases yield protein precipitation at frozen temperature, but also simplifies the process by decreasing the requirement for deep freezing.

### Example 4

### Restoring Protein Functionality

The treatment to restore protein functionality after freeze-thaw procedures is an important step. In this experiment, the precipitated protein samples in Example 1 were used and suspended with 2 volumes of water. Slow mixing did not dissolve or disperse the precipitate. However, upon high speed blending in a blender for 1.5 min, all the aggregated particles were dissolved or dispersed for all the samples. Protein solubility or dispersibility reached almost 100%. The solutions or emulsions were very stable. There was little settlement at the bottom, even after storage at a refrigerator for several days.

In another set of samples, the precipitated protein was slurred with 2 volumes of hot water with gentle stirring. It dissolved or dispersed most particles. Yet, heating along appeared to be less effective in restoring protein functionality than homogenization or high shearing treatment. Combining the two actions, heating and high shearing, can also be effective.

### Example 5

### Making Soy Protein Isolate

To a 1.5 liters cup fitted to a home blender, 1000 ml of tap water and 75 g of defatted soy white flakes (with a NSI of 84) were added, and then blended for 1 min at a higher speed. The hydrated slurry was filtered with a cloth. The fiber fraction (okara) was discarded. The filtrate (extract) was frozen at a home refrigerator's freezing chamber for 5 days, and thawed at a room temperature for 3 hr and then at a refrigerator for additional 40 hrs. The protein in the extract precipitated as a result of the freeze-thaw treatment. The supernatant was decanted carefully and saved. The residue was a protein isolate, which was suspended with 1 portion of water by weight. The suspension was blended for 2 minutes with the home blender at the highest speed. It was a stable emulsion and had attractive creamy white color (almost as white as dairy milk).

### Example 6

### Making Soy Protein Concentrates

The procedure was same in Example 5 except that before the cold temperature treatment, the fiber fraction (okara) was not removed. The slurry was frozen directly. The end product was a soy protein concentrate, having excellent solubility and attractive white color.

### Example 7

### Gelation Properties of Cryoprecipitated Soy Proteins

Soy protein isolates made according to Example 5 and concentrates made according to Example 6, were diluted with water to have a solid content in the range of 15-25%. The mixtures were blended for 2 minutes and then heated to 95 degrees C. for 15 minutes, with occasional stirring. The heated mixtures were the put into a refrigerator and stored for 12 hours. All samples formed firm gels.

### Example 8

### Making Full-Fat Soy Protein Concentrate

To a 1.5 liters cup fitted to a home blender, 1000 ml of tap water and 100 g of enzyme-active full-fat soy flour (100 mesh size) were added, and then blended for 1 min at a higher speed. The slurry was filtered to remove fiber. The filtrate was then frozen at a home refrigerator's freezing chamber for 6 days, and thawed at a refrigerate temperature for 2 days. The protein and lipid in the filtrate associated with each other and precipitated together as a result of the freeze-thaw treatment. The supernatant was decanted carefully. The residue was a full-fat soy protein concentrate. After blending with 2 portions of water for 2 minutes with the home blender at the highest speed, a stable emulsion resulted, having excellent stability and attractive color.

### Example 10

### Making Soy Protein Concentrate in Winter Season

The experiment was conducted during the winter season at Missouri. To a 1.5 liters cup fitted to a home blender, 1000 ml of tap water and 100 g of soy white flakes with 100 mesh size were added, and then blended for 1 min at a higher speed. This was repeated 5 times. The combined slurry in 5 operations was put into a 6 liters plastic container. The container was put in outdoor backyard and allowed to freeze. After 7 days of freezing outside, the container was brought back indoor and allowed to thaw slowly. After complete thawing, the supernatant was decanted carefully. The residue was a soy protein concentrate. After blending with 1 portion of water for 2 minutes with the home blender at the highest speed, a stable emulsion resulted, having excellent stability and attractive color.

### Example 11

### Fractionating Soy Protein Components

To a 1.5 liters cup fitted to a home blender, 150 ml of tap water and 20 g of defatted soy white flakes (with a NSI of 84) were added, and blended for 30 seconds at a higher speed. The slurry was filtered. The filtrate was tested for total protein content before being put in a freezer (18 degrees C. below zero). After freezing for 8 hours, the sample was thawed first at a room temperature for 2 hour and then at a refrigerator temperature for overnight. The top liquid was carefully decanted and saved. Its protein content was measured. The precipitate was an 11S-rich faction, consisting about 35% of the total protein in the original filtrate. The top liquid was frozen again for additional 3 days before cold thawing. The supernatant was again decanted carefully and tested for protein content. The residue was a 7S rich fraction, constituting about 30% of protein in the original filtrate. Both 11S-rich and 7S-rich fractions were reconstituted with 2 portions of water by weight. The suspensions were blended for 2 minutes with the home blender at a highest speed. Both showed excellent stability and creamy white color.

### Example 12

### Recovering Soluble Carbohydrates from the Supernatant

The supernatant from Example 5 was passed through an ultrafiltration membrane system having a molecular weight cutoff of 1000. The passed liquid was concentrated and dried to become a preparation that was rich in soybean soluble carbohydrates, mostly sucrose, raffinose and stachyose. The resulting retentate was also dried. It was rich in bioactive proteins and peptides, including trypsin inhibitors and lunasin.

### Example 13

### Recovering Borman-Birk Inhibitor from the Supernatant

The supernatant from Example 6 was treated with an equal volume of acetone and mixed for 10 min. The mixture was allowed to settle for 1 hour before the liquid layer was decanted. The precipitated material was vacuum filtered to remove acetone and acetone-soluble material and then air-dried. It is a crude BB inhibitor preparation. To further concentrate BB inhibitor in the preparation, after air drying, the precipitated material was dispersed in water and the resulting aqueous solution was ultrafiltered using a 1500 molecular weight cut-off spiral wound membrane. The retentate from the ultrafiltration process was spray dried. It was a BB inhibitor concentrate.

Thus, there has been shown and described a new and useful method for extracting, concentrating and fractionating proteins from plant materials, particularly these from oilseeds, legumes, and cereals. Although this invention has been exemplified for purposes of illustration and description by reference to certain specific embodiments, it will be apparent to those skilled in the art that various modifications, alterations, and equivalents of the illustrated examples are possible. Any such changes, which derive directly from the teachings herein, and which do not depart from the spirit and scope of the invention, are deemed to be covered by this invention.

1. A method for extracting and concentrating proteins from a protein-rich plant material, comprising:
(1) preparing a plant material containing proteins;
(2) mixing or blending said plant material with an aqueous medium;
(3) maintaining the mixture at a low temperature;
(4) thawing said mixture when necessary;
(5) separating the precipitated fraction from the supernatant; and
(6) restoring functional properties of said precipitated fraction,
whereby creating a vegetable protein concentrate or isolate having excellent functional properties, taste, visual appearance, and nutritional values.

2. The method of claim 1, wherein said aqueous medium is selected from the group consisting of water, an alkaline solution, a salt solution, and a buffer solution.

3. The method of claim 1, wherein said plant material is an oilseed material selected from the group consisting of soybeans, canola, peanuts, cottonseed, sunflower and other oilseeds.

4. The method of claim 1, wherein said low temperature in step (3) is about 8 degrees Centigrade (8° C.) to about 80 degrees Centigrade below zero (−18° C.).

5. The method of claim 4, wherein duration for the low temperature treatment is about 2 hours to about 30 days.

6. The method of claim 1, which also includes a step of removing insoluble fraction from the mixture before the step (3) of maintaining said mixture at a low temperature.

7. The method of claim 1, which also includes a step of pretreatment selected from the group consisting of heating, acidification, addition of an additive, concentration, dilution, clarification, fermentation, and a combination thereof, before the step (3).

8. The method of claim 1, wherein the step (6) of restoring functional properties of the precipitated fraction comprising:
(6)(a) making an aqueous slurry from said precipitated fraction, and
(6)(b) subjecting said aqueous slurry to a processing step selected from the group consisting of shear, heating, and a combination thereof.

9. The method of claim 1, which also includes a processing step selected from the group of heating, neutralization, drying, and a combination thereof, after the step (6).

10. A protein concentrate formed by the method of claim 1.

11. A protein isolate formed by the method of claim 6.

12. A method for extracting and fractionating proteins from a protein-rich plant material comprising:
(1) preparing a plant material containing proteins;
(2) mixing or blending said plant material with an aqueous medium;
(3) removing the insoluble fraction from the mixture;
(4) maintaining the extract at a low temperature;
(5) thawing said extract when necessary;
(6) separating the precipitated fraction from the supernatant;
(7) repeating the steps of (4), (5) and (6) for said supernatant obtained in the step (6) for additional cycles;
(8) restoring functional properties for each precipitated fraction.

13. The method of claim 12, wherein said low temperature in the step (4) is about 8 degrees Centigrade (8° C.) to about 80 degrees Centigrade below zero (−18° C.).

14. The method of claim 13, wherein duration the low temperature treatment is between about 2 hours to about 20 days.

15. The method of claim 12, wherein the low temperature treatment in the step (7) being lower in temperature and maintained for longer duration than the previous cycle;

16. The method of claim 12, wherein the step of restoring functional properties of a precipitated fraction comprising:
(8)(a) making an aqueous slurry from said precipitated fraction, and
(8)(b) subjecting said slurry to a processing step selected from the group consisting of shear, heating, and a combination thereof.

17. Fractionated protein components formed by the method of claim 12.

18. A method for extracting and concentrating a bioactive component from a plant material, comprising:
(1) preparing a plant material containing a bioactive component;
(2) mixing said plant material with a solvent to extract said bioactive component;
(3) maintaining the mixture at a low temperature;
(4) thawing said mixture when necessary;
(5) separating the supernatant containing said active component from the precipitated fraction;
(6) isolating and concentrating said active component in said supernatant.

19. The method of claim 18, wherein said solvent is selected from the group consisting of water, an alkaline solution, a salt solution, a buffer solution, an organic solvent, a mixed organic solvent, and an aqueous organic solvent.

20. The method of claim 18, wherein said low temperature is about 8 degrees Centigrade (8° C.) to about 80 degrees Centigrade below zero (−18° C.).
